(19) United States
(12) Patent Application Publication
(10) Pub. No.: US 2012/0025666 A1
(43) Pub. Date: Feb. 2, 2012

(54) BRUSH DEVICE HAVING A LITZ WIRE FOR AN ELECTRIC MACHINE

(76) Inventor: Michael Bayer, Ludwigsburg (DE)

(21) Appl. No.: 12/734,301

(22) PCT Filed: Sep. 26, 2008
(86) PCT No.: PCT/EP2008/062944

§ 371 Date: Oct. 21, 2011

(30) Foreign Application Priority Data
Oct. 24, 2007 (DE) 102007051125.8

(51) Int. Cl. H01R 39/36; H01R 39/415

(52) U.S. Cl. 310/247; 310/249

(57) ABSTRACT

A brush device for an electric machine is described, having a brush mount that has a brush which is accommodated in it and having a first integrated litz wire, having a first spring, which prestresses the brush against a commutator. In order to create an E machine having an improved service life, at least one second litz wire is developed integrated into the brush.

### FIELD OF THE INVENTION

The present invention relates to a brush device for an electric machine having a brush mount, and having a brush accommodated in the brush mount, into which a first litz wire is integrated, and having a spring which prestresses the brush in the brush mount against a commutator.

### BACKGROUND INFORMATION

It is understood that there are mechanically commutated electric machines (E machines) that have in each case one litz wire integrated in the brush. Mechanically commutated DC current motors are used to start internal combustion engines. The current is introduced into the armature winding via the commutator via one or more pair(s) of brushes. In most cases these brushes are made of a sintered material, which predominantly includes copper and graphite components. Because of their high proportion of graphite, the brushes are also called carbon brushes. These brushes as well as the commutator are subject to wear during operation.

The DC motor, which is also designated as starter, is designed for short-term operation and is usually provided for 30,000 to 60,000 switching cycles. The litz wire is positioned in the brush in the radial direction in series behind a spring. The brush is pressed against the commutator and has a wear length of limited possibility. As seen in lateral cross section, the wear length extends from the contact surface of the brush to the commutator, up to the beginning of the cross section of the litz wire pressed into the brush. Such a wear length is not sufficient for a use at higher loads, such as for higher switching cycles and longer running times for a certain service life that is required. The following brushes and brush holders are also known from the related art.

German patent document DE 23 50 456 A1 discusses an interchangeable brush holder for an electric machine having a brush holder support on which a spring is fastened having a carbon brush. The carbon brush is able to be pressed against the slip ring or commutator only up to a certain degree of wear.

U.S. Pat. No. 4,536,670 discusses an electric brush having a built-in brush wear sensor in the brush body.

### SUMMARY OF THE INVENTION

The present invention is based on the object of further developing a brush device, of the type mentioned at the outset, in such a way that, compared to the related art, an E machine will have a higher number of operations and a longer running time having an improved service life.

According to the present invention, this object may be attained by the subject matter described herein. Advantageous refinements are derived from the further descriptions and disclosures herein.

One important aspect of the present invention is to increase the wear length by developing the litz wire offset parallel to the spring in the brush, in the radial direction R. According to the present invention, the litz wire is thus no longer located under the spring, but slightly offset. Consequently, the wear length increases, in response to an offset litz wire, at least by the length by which the litz wire is built in toward the rear, in the direction of the bottom of the brush mount, integrated in an offset manner.

Because the litz wire is able to be situated in the brush parallel to the spring, the litz wire no longer necessarily represents the sole wear limitation.

According to one exemplary embodiment refining the present invention, at least one second litz wire is developed in the brush in an integrated manner. Based on the subdivision of the electric current from one litz wire to at least one further litz wire, the cross section of the litz wires may be reduced, so that the wear length at equal space is increased in comparison to a litz wire that is situated in the brush, under the spring. This wear length may already represent a sufficient increase in the wear length to achieve a desired service life.

According to another exemplary embodiment refining the present invention, the first and at least the second litz wire are developed offset in the brush, in the radial direction parallel to the spring. In that way, the wear length is increased still more. It should only be observed that the first and second litz wires should be situated at a sufficient distance from the lateral edge of the brush and from the edge to the contact surface of the brush to the spring, for reasons of stability.

The same cross section of the litz wires may advantageously lead to improved heat conductivity within the brush, i.e. to a homogeneous heat flow.

According to one exemplary embodiment, the first and at least the second litz wire are situated in edge regions of the brush, as seen in lateral cross section. This has the advantage that the wear length increases because the litz wires are distanced from the central radial direction in which the brush has a lower wear length, based on the radial commutator.

According to another exemplary embodiment refining the present invention, the first and at least the second litz wire are developed in the radial direction parallel to the spring in the brush.

According to one exemplary embodiment, the first and the second litz wire are developed ahead of and behind the spring, in a first and a second brush start. Consequently, the first and the at least second litz wire are situated parallel before and behind the at least one spring.

According to one exemplary development further refining the present invention, the dimensions, especially of the first and second litz wire are smaller than in a brush device having one litz wire. In this context, the overall cross section of all the litz wires in the brush may be greater than the cross section of one single litz wire according to the related art. A larger overall cross section provides improved heat dissipation, as well as improved power consumption and power decrease at current peaks, and thus prolongs the service life.

In order to increase the service life of an electric machine, in the case of a brush that is worn out early, the brush device is advantageously developed to be exchangeable.

According to another exemplary embodiment, more than one spring are able to press the brush in the brush support to the commutator. This creates a more homogeneous contact pressure together with an improved service life, because spring rate C is able to be designed smaller.

According to the exemplary embodiments and/or exemplary methods of the present invention, in the production method of a brush device described above, having at least two litz wires in one brush, at least two litz wires are press-fit in the brush. This represents a simple method of increasing the service life of a brush device for an electric machine.

It is understood that the features mentioned above and the ones to be explained below, are able to be used not only in the individually indicated combination but in other combinations as well.

The present invention is elucidated below in greater detail with the aid of an exemplary embodiment and with reference to the drawing.

### BRIEF DESCRIPTION OF THE DRAWING

FIG. 1 shows a schematic side view of a brush device.

### DETAILED DESCRIPTION

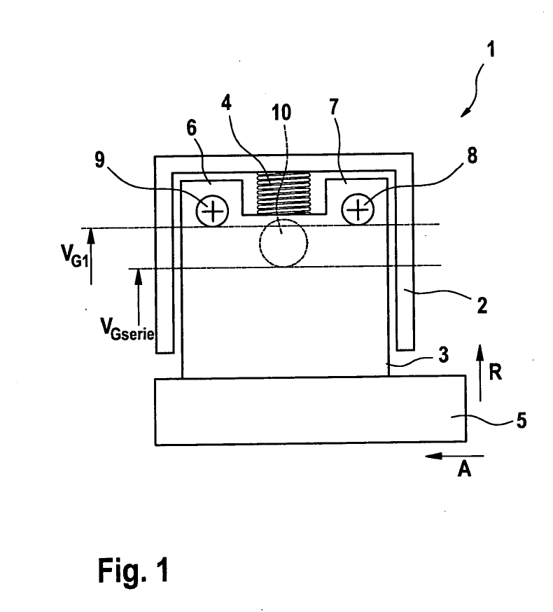

In a schematic side view, FIG. 1 shows a brush device 1, according to the exemplary embodiments and/or exemplary methods of the present invention, having a brush support 2, in which a brush 3 is accommodated. Brush 3 is prestressed against commutator 5 using a spring 4, and is pressed against it. In radial direction R, brush 3 has brush starts 6, 7, situated in parallel to spring 4, which are situated in the direction of axis A in front of and behind spring 4. According to a production method according to the present invention, in brush starts 6, 7, at least two litz wires, a first litz wire 8 and a second litz wire 9 are press-fit with brush 3. The first and second litz wires 8, 9 have a smaller cross section than a single litz wire 10 according to the related art, which is situated in the radial direction serially under spring 4 in brush 3. Litz wire 10 is drawn in as a dotted line, since it represents the related art, and not the exemplary embodiment according to the present invention. However, the sum of the cross sections of first and second litz wires 8, 9 is greater than the cross section of a single litz wire 10. As a result, an improved homogeneous heat dissipation is produced, and at the same time, because of the parallel arrangement of first and second litz wires 8, 9 with respect to spring 4, wear limitation V_{Gseries}, shown by a dotted line, being increased to wear limitation V_{G1}, according to the exemplary embodiments and/or exemplary methods of the present invention. Litz wires 8, 9 according to the exemplary embodiments and/or exemplary methods of the present invention each have, for instance, a cross section of 2.5 mm², while in a usual litz wire 10 the cross section has a size of 4 mm². Because of the increased wear length of brushes 3, an E machine, having a brush device 1 according to the exemplary embodiments and/or exemplary methods of the present invention, has a longer service life, at longer running times and increased switching cycles.

All the figures show only schematic illustrations which are not to scale. In all other respects, reference is made especially to the drawing as being important for the exemplary embodiments and/or exemplary methods of the present invention.

1-8. (canceled)

9. An electric machine, comprising:
a commutator;
a first litz wire; and
a brush device, the brush device including a brush mount, a brush accommodated in the brush mount, in which the first litz wire is integrated, and a spring which prestresses the brush in the brush mount against the commutator;
wherein the first litz wire is offset in a radial direction R parallel to the spring in the brush, and
wherein a longitudinal direction of the litz wire is oriented transversely to the radial direction R.

10. The electric machine of claim 9, wherein the first litz wire is press-fit with the brush in a first brush start.

11. The electric machine of claim 10, wherein the first brush start is situated in front of a spring in an axial direction.

12. The electric machine of claim 9, further comprising:
a second litz wire, which is press-fit with the brush in a second brush start.

13. The electric machine of claim 12, wherein a recess is situated between the first brush start and the second brush start, in which the spring is situated.

14. The electric machine of claim 12, wherein the first litz wire and the second litz wire are situated parallel to each other.

15. The electric machine of claim 9, wherein the brush device is exchangeable.

16. The electric machine of claim 9, further comprising:
at least one second spring that prestresses the brush against the commutator.
